(19) United States
(12) Patent Application Publication
(10) Pub. No.: US 2026/0074848 A1
(43) Pub. Date: Mar. 12, 2026

(54) METHOD AND APPARATUS FOR WIRELESS COMMUNICATION

(71) Applicant: QUECTEL WIRELESS SOLUTIONS CO., LTD., Shanghai (CN)

(72) Inventor: Ling LYU, Shanghai (CN)

(21) Appl. No.: 19/390,431

(22) Filed: Nov. 14, 2025

Related U.S. Application Data
(63) Continuation of application No. PCT/CN2024/105525, filed on Jul. 15, 2024.

(51) Int. Cl. H04L 5/00; H04W 72/044

(52) U.S. Cl. CPC H04L 5/0044; H04L 5/0007; H04W 72/044

(57) ABSTRACT

Disclosed are a method and apparatus for wireless communication. One example method includes: determining a first orthogonal cover code (OCC) sequence; determining, based on first information, a start time-domain position for an uplink transmission based on the first OCC sequence; and performing, an uplink transmission by using the first OCC sequence, wherein the first OCC sequence is an OCC sequence in an OCC sequence set that is received from a network device, and the first information is associated with timing of at least one of the OCC sequence set or the uplink transmission.

### CROSS-REFERENCE TO RELATED APPLICATIONS

This application is a continuation of International Application No. PCT/CN2024/105525, filed on Jul. 15, 2024, the disclosure of which is hereby incorporated by reference in its entirety.

### TECHNICAL FIELD

The present disclosure relates to the technical field of communications, and in particular, relates to a method and apparatus for wireless communication.

### BACKGROUND

In some communication systems, such as non-terrestrial network (NTN) systems, demands for uplink communication are significant. When the uplink channel supports retransmissions, the burden on uplink transmission is further increased. In such systems, a plurality of terminal devices may enhance uplink capacity gain while maintaining enhanced uplink coverage by using an orthogonal cover code (OCC). However, how to use the OCC to achieve uplink enhancement has become a technical problem that needs to be solved.

### SUMMARY

Embodiments of the present disclosure provide a method and apparatus for wireless communication. Various aspects of embodiments of the present disclosure are described in detail hereinafter.

In a first aspect of the embodiments of the present disclosure, a method for wireless communication is provided. The method includes: determining, by a first terminal device, a first OCC sequence; and determining, by the first terminal device in accordance with first information, a start time-domain position for an uplink transmission based on the first OCC sequence; wherein the first OCC sequence is any OCC sequence in an OCC sequence set, wherein the OCC sequence set is configured for a plurality of terminal devices including the first terminal device to respectively perform a plurality of uplink transmissions, and the first information is associated with timing of the OCC sequence set and/or the plurality of uplink transmissions.

In a second aspect of the embodiments of the present disclosure, a method for wireless communication is provided. The method includes: determining, by a network device in accordance with first information, a start time-domain position for an uplink transmission performed by a first terminal device based on a first OCC sequence; wherein the first CCC sequence is any OCC sequence in an OCC sequence set, wherein the OCC sequence set is configured for a plurality of terminal devices including the first terminal device to respectively perform a plurality of uplink transmissions, and the first information is associated with timing of the OCC sequence set and/or the plurality of uplink transmissions.

In a third aspect of the embodiments of the present disclosure, an apparatus for wireless communication is provided. The apparatus is a first terminal device. The apparatus includes: a first determining unit, configured to determine a first OCC sequence; and a second determining unit, configured to determine, in accordance with first information, a start time-domain position for an uplink transmission performed by a first terminal device based on the first OCC sequence; wherein the first OCC sequence is any OCC sequence in an OCC sequence set, wherein the OCC sequence set is configured for a plurality of terminal devices including the first terminal device to respectively perform a plurality of uplink transmissions, and the first information is associated with timing of the OCC sequence set and/or the plurality of uplink transmissions.

In a fourth aspect of the embodiments of the present disclosure, an apparatus for wireless communication is provided. The apparatus is a network device. The apparatus includes: a determining unit, configured to determine, in accordance with first information, a start time-domain position for an uplink transmission performed by a first terminal device based on a first OCC sequence, wherein the first OCC sequence is any OCC sequence in an OCC sequence set, wherein the OCC sequence set is configured for a plurality of terminal devices including the first terminal device to respectively perform a plurality of uplink transmissions, and the first information is associated with timing of the OCC sequence set and/or the plurality of uplink transmissions.

In a fifth aspect of the embodiments of the present disclosure, a communication device is provided. The communication device includes a memory and a processor, wherein the memory is configured to store one or more programs, and the processor is configured to call the one or more programs stored in the memory to perform the method according to the first aspect or the second aspect.

In a sixth aspect of the embodiments of the present disclosure, a device is provided. The device includes a processor, wherein the processor is configured to call one or more programs from a memory to perform the method according to the first aspect or the second aspect.

In a seventh aspect of the embodiments of the present disclosure, a chip is provided. The chip includes a processor, wherein the processor is configured to call one or more programs from a memory to cause a device equipped with the chip to perform the method according to the first aspect and or second aspect.

In an eighth aspect of the embodiments of the present disclosure, a computer-readable storage medium storing one or more programs therein is provided, wherein the one or more programs, when loaded and run by a computer, cause the computer to perform the method according to the first aspect or the second aspect.

In a ninth aspect of the embodiments of the present disclosure, a computer program product is provided. The computer program product includes one or more programs, wherein the one or more programs, when loaded and run by a computer, cause the computer to perform the method according to the first aspect or the second aspect.

In a tenth aspect of the embodiments of the present disclosure, a computer program is provided. The computer program, when loaded and run by a computer, causes the computer to perform the method according to the first aspect or the second aspect.

In the embodiments of the present disclosure, in a case where the first terminal device determines the first OCC sequence, the first terminal may determine, based on the first information, the start time-domain position for the uplink transmission based on the first OCC sequence. The first information is timing-related to a plurality of uplink transmissions respectively performed by a plurality of terminal devices, and/or to an OCC sequence set including the first OCC sequence. Thus, each of the plurality of terminal devices may determine a time-domain position for uplink transmission using an OCC sequence, thereby solving the alignment issue for uplink transmissions based on the OCC sequence set.

### BRIEF DESCRIPTION OF THE DRAWINGS

FIG. 1 illustrates a wireless communication system according to some embodiments of the present disclosure;

FIG. 2 illustrates an NTN system according to some embodiments of the present disclosure;

FIG. 3 illustrates another NTN system according to some embodiments of the present disclosure;

FIG. 4 is a schematic flowchart of a method for wireless communication according to some embodiments of the present disclosure;

FIG. 5 is a schematic diagram of a possible implementation of an OCC sequence set;

FIG. 6 is a schematic diagram of another possible implementation of an OCC sequence set;

FIG. 7 is a schematic flowchart of another method for wireless communication according to some embodiments of the present disclosure;

FIG. 8 is a schematic flowchart of a possible implementation of repetition of transmissions according to some embodiments of the present disclosure

FIG. 9 is a schematic diagram of a possible implementation of determining a reference timing;

FIG. 10 is a schematic diagram of another possible implementation of determining a reference timing;

FIG. 11 is a schematic structural diagram of an apparatus for wireless communication according to some embodiments of the present disclosure;

FIG. 12 is a schematic structural diagram of another apparatus for wireless communication according to some embodiments of the present disclosure; and

FIG. 13 is a schematic structural diagram of a communication device according to some embodiments of the present disclosure.

### DETAILED DESCRIPTION

The technical solutions according to the embodiments of the present disclosure are described in detail clearly and completely hereinafter with reference to the accompanying drawings for the embodiments of the present disclosure. Apparently, the described embodiments are only a portion of embodiments of the present disclosure, but not all the embodiments of the present disclosure. Based on the embodiments of the present disclosure, all other embodiments derived by persons of ordinary skill in the art without any creative efforts shall fall within the protection scope of the present disclosure.

The embodiments of the present disclosure may be applied to various communication systems. For example, the embodiments of the present disclosure may be applied to a global system for mobile communications (GSM) system, a code-division multiple access (CDMA) system, a wideband code-division multiple access (WCDMA) system, a general packet radio service (GPRS) system, a long-term evolution (LTE) system, an advanced long-term evolution (LTE-A) system, a new radio (NR) system, an evolved system of an NR system, an LTE-based access to unlicensed spectrum (LTE-U) system, an NR-based access to unlicensed spectrum (NR-U) system, a non-terrestrial network (NTN) system, a universal mobile telecommunications system (UMTS), a wireless local area network (WLAN), a wireless fidelity (Wi-Fi) system, or a 5^{th} generation (5G) system. The embodiments of the present disclosure may also be applied to other communication systems, such as future communication systems. For example, the future communication system may be a 6^{th} generation (6G) mobile communication system, a satellite communication system, or the like.

Traditional communication systems support a limited number of connections and are also simpler to implement. However, with the development of communication technologies, a communication system supports not only traditional cellular communication but also one or more other types of communication. For example, the communication system may support one or more of: device-to-device (D2D) communications, machine-to-machine (M2M) communications, machine-type communications (MTC), enhanced MTC (eMTC), vehicle-to-vehicle (V2V) communications, and vehicle-to-everything (V2X) communications. The embodiments of the present disclosure may also be applied to communication systems that support the aforementioned communication modes.

The communication system in the embodiments of the present disclosure may be applied to carrier aggregation (CA) scenarios, dual-connectivity (DC) scenarios, and standalone (SA) networking scenarios.

The communication system in the embodiments of the present disclosure may be applied to unlicensed spectrum. The unlicensed spectrum may also be considered as shared spectrum. Alternatively, the communication system herein may be applied to licensed spectrum. The licensed spectrum may also be considered as dedicated spectrum.

The embodiments of the present disclosure may be applied to an NTN system. As an example, the NTN system may be a 4G-based NTN system, an NR-based NTN system, an Internet of things (IoT)-based NTN system, or a narrowband Internet of things (NB-IoT)-based NTN system.

The communication system may include one or more terminal devices. The terminal device according to the embodiments of the present disclosure may also be referred to as a user equipment (UE), an access terminal, a subscriber unit, a subscriber station, a mobile station (MS), a mobile terminal (MT), a remote station, a remote terminal, a mobile device, a user terminal, a wireless communication device, a user agent, a user apparatus, or the like.

In some embodiments, the terminal device may be a station (STA) in a WLAN. In some embodiments, the terminal device may be a cellular phone, a cordless phone, a Session Initiation Protocol (SIP) phone, a wireless local loop (WLL) station, a personal digital assistant (PDA), a handheld device having a wireless communication function, a computing device, a processing device connected to a wireless modem, a vehicle-mounted device, a wearable device, a terminal device in a next-generation communication network (e.g., NR system), a terminal device in a future evolved public land mobile network (PLMN), or the like.

In some embodiments, the terminal device may refer to a device providing voice and/or data connectivity for users. For example, the terminal device may be a handheld device, a vehicle-mounted device or the like having a wireless connection function. In some specific examples, the terminal device may be a mobile phone, a pad, a laptop, a palmtop, a mobile Internet device (MID), a wearable device, a virtual reality (VR) device, an augmented reality (AR) device, a wireless terminal in industrial control, a wireless terminal in self-driving, a wireless terminal in remote medical surgery, a wireless terminal in smart grid, a wireless terminal in transportation safety, a wireless terminal in smart city, a wireless terminal in smart home, or the like.

In some embodiments, the terminal device may be deployed on land. For example, the terminal device may be deployed indoors or outdoors. In some embodiments, the terminal device may be deployed on water, for example, on a ship. In some embodiments, the terminal device may be deployed in the air, for example, on an airplane, a balloon, or a satellite.

In addition to the terminal device, the communication system may also include one or more network devices. The network device according to the embodiments of the present disclosure may be a device for communicating with the terminal device. The network device may also be referred to as an access network device or a radio access network device. The network device may be, for example, a base station. The network device according to the embodiments of the present disclosures may refer to a radio access network (RAN) node (or device) that accesses (connects) a terminal device to a wireless network. The base station may broadly cover or replace various names such as, a node B (NodeB), an evolved base station (evolved NodeB, eNB), a next generation base station (next generation NodeB, gNB), a relay station, a transmission and reception point (TRP), a transmission point (TP), an access point (AP), a primary station MeNB, and a secondary station SeNB, an multi-standard radio (MSR) node, a home base station, a network controller, an access node, a wireless node, a transmission node, a transceiver node, a baseband unit (BBU), a remote ratio unit (RRU), an active antenna unit (AAU), a remote radio head (RRH), and a central unit (CU), a distributed unit (DU), a positioning node, and the like. The base station may be a macro base station, a micro base station, a relay node, a donor node, or the like, or a combination thereof. The base station may also refer to a communication module, a modem, or a chip configured in the above apparatus or device. The base station may also be a mobile switching center and a device in D2D, V2X, or M2M communications to assume the function of a base station, a network-side device in a 6G network, a device in a future communication system to assume the function of a base station, or the like. The base station may support networks of the same or different access technologies. The embodiments of the present disclosure do not limit the specific technology adopted by a network device and the specific device form.

The base station may be stationary or mobile. For example, a helicopter or unmanned aerial vehicle may be configured to serve as a mobile base station, and one or more cells may move depending on the location of the mobile base station. In other examples, the helicopter or unmanned aerial vehicle may be configured to serve as a device to communicate with another base station.

In some deployments, the network device according to the embodiments of the present disclosure may refer to a CU or a DU, or the network device includes a CU and a DU. The gNB may also include an AAU.

By example rather than limitation, in the embodiments of the present disclosure, the network device may have mobile characteristics. For example, the network device may be a mobile device. In some embodiments of the present disclosure, the network device may be a satellite or a balloon station. In some embodiments of the present disclosure, the network device may also be a base station deployed on land, in water, or in other locations.

In embodiments of the present disclosure, the network device may provide services for a cell, and the terminal device communicates with the network device using transmission resources (for example, frequency-domain resources, or in other words, spectrum resources) used by the cell. The cell may be a cell corresponding to the network device (e.g., base station). The cell may belong to a macro base station or a base station corresponding to a small cell. Here, the small cell may include, but is not limited to: a metro cell, a micro cell, a pico cell, or a femto cell. These small cells are characterized by small coverage areas and low transmission power, making them suitable for providing high-rate data transmission services.

Exemplarily, FIG. 1 is a schematic structural diagram of an architecture of a wireless communication system 100 according to some embodiments of the present disclosure. As illustrated in FIG. 1, the wireless communication system 100 may include a network device 110. The network device 110 may be a device in communication with a terminal device 120 (or referred to as a communication terminal or a terminal). The network device 110 may provide communication coverage for a specific geographical region, and may communicate with any terminal device within the coverage area.

FIG. 1 exemplarily illustrates one network device and two terminal devices. In some embodiments of the present disclosure, the wireless communication system 100 may include a plurality of network devices and each of the network devices provides a coverage area for another number of terminal devices, which is not limited herein.

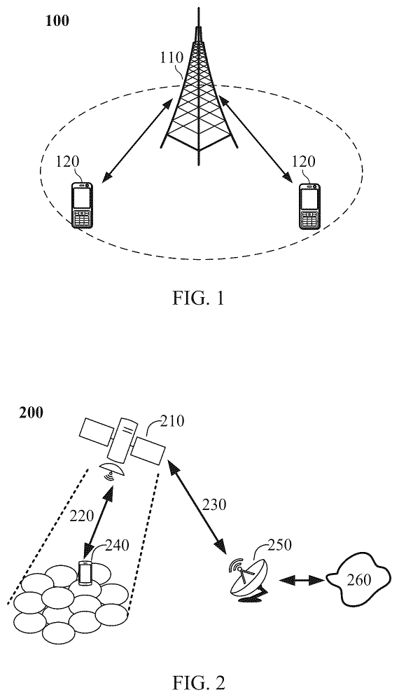

Exemplarily, FIG. 2 is a schematic diagram of an architecture of an NTN system 200. The NTN system 200 illustrated in FIG. 2 uses a satellite 210 as an aerial platform. As illustrated in FIG. 2, the satellite radio access network includes the satellite 210, a service link 220, a feeder link 230, a terminal device 240, a gateway (GW) 250, and a network 260 that includes a base station and a core network.

The satellite 210 is a spacecraft based on a space platform. The service link 220 refers to a link between the satellite 210 and the terminal device 240. The feeder link 230 refers to a link between the gateway 250 and the satellite 210. The Earth-based gateway 250 connects the satellite 210 to the base station or the core network, depending on the choice of the NTN architecture.

The NTN architecture illustrated in FIG. 2 is a bent-pipe transponder architecture. In this architecture, the base station is deployed on the ground behind the gateway 250, and the satellite 210 acts as a relay. The satellite 210 operates as a relay that forwards signals from the feeder link 230 to the service link 220, or conversely, forwards signals from the service link 220 to the feeder link 230. That is, the satellite 210 does not have the functions of a base station; and communication between the terminal device 240 and the base station in the network 260 requires relaying via the satellite 210.

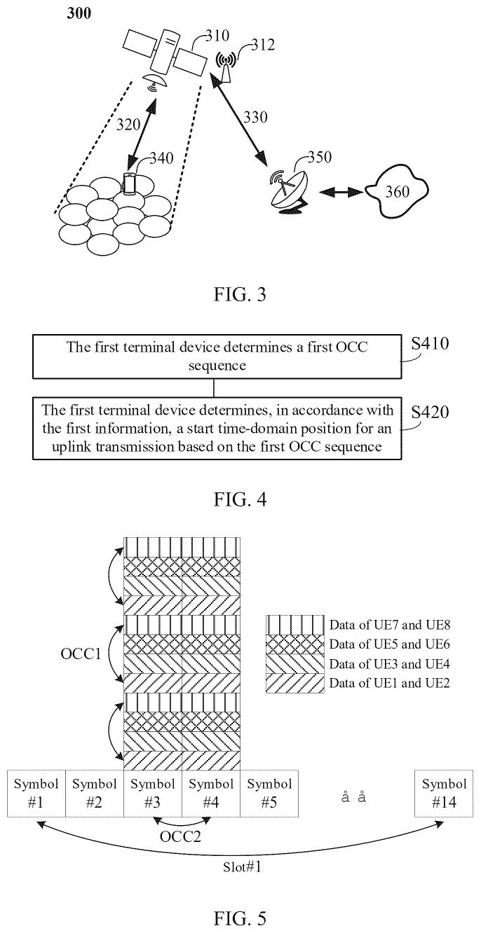

Exemplarily, FIG. 3 is a schematic diagram of another architecture of the NTN system 200. As illustrated in FIG. 3, the satellite radio access network 300 includes a satellite 310, a service link 320, a feeder link 330, a terminal device 340, a gateway 350, and a network 360. Different from FIG. 2, a base station 312 is deployed on the satellite 310, and the network 360 behind the gateway 350 only includes the core network.

The NTN architecture illustrated in FIG. 3 is a regenerative transponder architecture. In this architecture, the satellite 310 carries a base station 312 and may be directly connected to the Earth-based core network via a link. The satellite 310 has the functions of a base station, and the terminal device 340 may directly communicate with the satellite 310. Therefore, the satellite 310 may be referred to as a network device.

The communication system as illustrated in FIG. 2 and FIG. 3 may include a plurality of network devices. Each of the network devices provides a coverage area for terminal devices in another number, which is not limited in the embodiments of the present disclosure.

In the embodiments of the present disclosure, each of the communication systems illustrated in FIG. 1 to FIG. 3 may also include other network entities such as a mobility management entity (MME), an access and mobility management function (AMF), or the like, which is not limited in the embodiments of the present disclosure.

It should be understood that a device with communication functions in the network/system of the embodiments of the present disclosure may be referred to as a communication device. Taking the wireless communication system 100 illustrated in FIG. 1 as an example, the communication devices may include the network device 110 and the terminal device 120, both having communication functions. The network device 110 and the terminal device 120 may be the specific devices described above, and details are not repeated here. The communication devices may also include other devices in the wireless communication system 100, such as other network entities like a network controller, a mobility management entity, or the like. Embodiments of the present disclosure do not impose limitations in this regard.

For ease of understanding, some related technical knowledge involved in the embodiments of the present disclosure is described hereinafter. The following related technologies, as optional solutions, may be randomly combined with the technical solutions according to the embodiments of the present disclosure, which all fall within the protection scope of the embodiments of the present disclosure. The embodiments of the present disclosure include at least part of the following content.

With the development of communication technologies, communication systems (e.g., 5G) may unlock the market potential for integrating satellite and terrestrial network infrastructures. For example, the 5G standard enables the NTN, including its satellite segment, to become a recognized part of the 3^{rd} Generation Partnership Project (3GPP) 5G connectivity infrastructure.

The NTN refers to a network or network segment that uses radio frequency (RF) resources on platforms such as satellites or unmanned aerial systems (UAS). Taking satellites as an example, communication satellites are classified according to their orbital altitude into low Earth orbit (LEO) satellites, medium Earth orbit (MEO) satellites, geostationary Earth orbit (GEO) satellites, and high elliptical orbit (HEO) satellites, among others. The LEO is an Earth-centered orbit with an altitude of 2000 km or less, or with at least 11.25 periods per day and an eccentricity of less than 0.25. Most artificial objects in outer space are located in the LEO. The LEO satellites orbit the Earth at high speeds (high mobility) but on predictable or deterministic orbits.

Satellites at different orbital altitudes have different orbital periods. Exemplarily, the typical altitude for the LEO is 250 to 1500 km, with an orbital period of 90 to 120 minutes. The typical altitude for the MEO is 5000 to 25000 km, with an orbital period of 3 to 15 hours. The altitude for the GEO is approximately 35786 km, with an orbital period of 24 hours.

From FIG. 2 and FIG. 3, which use satellites as an example, it can be seen that typical scenarios for a terminal device accessing an NTN system involve either an NTN transparent payload or an NTN regenerative payload. The bent-pipe transponder architecture illustrated in FIG. 2 corresponds to the NTN transparent payload, while the regenerative transponder architecture illustrated in FIG. 3 corresponds to the NTN regenerative payload.

In the NTN system, the terminal device communicates with the network device via a satellite-borne or airborne platform. Since an aerial platform such as a satellite covers a large area, the number of terminal devices served within an NTN cell is typically larger than in a terrestrial network (TN) cell. To meet the uplink transmission needs of the terminal devices within the cell, the communication demand on the uplink (UL) is usually quite high.

Furthermore, when the uplink channel supports retransmission, the burden and overhead of uplink transmission are even greater. For example, when the physical uplink shared channel (PUSCH) supports retransmission based on a hybrid automatic repeat request (HARQ) mechanism, the network device needs to configure uplink resources for both the initial transmission and retransmission, which also increases the burden on uplink transmission.

For ease of understanding, the resource configuration for PUSCH initial transmission and retransmission is used as an example for explanation hereinafter. In the NTN system, a network device may configure transmission resources for the PUSCH in various ways.

As an example, the transmission resources for the PUSCH are indicated by downlink control information (DCI). For example, the relative position of the PUSCH with respect to the physical downlink control channel (PDCCH) is indicated by a K2+offset field in the DCI. In a TN system, offset=0. K2=0 indicates that the PUSCH is in the same slot as the PDCCH, K2=1 indicates that the PUSCH is in the slot following the one where the PDCCH is located, and so on. As another example, PUSCH transmission may be dynamically scheduled by a DCI format (DCI 0_0/0_1/0_2) in the PDCCH. In an NTN system, the terminal device may transmit the PUSCH on a resource set indicated by the DCI format.

As an example, the transmission resources for the PUSCH are determined by a response from the network side. For instance, in a 4-step random access (RA) procedure, the transmission of a message 3 (MSG3) on the PUSCH is scheduled by a random access response (RAR).

As an example, the transmission resources for the PUSCH are determined by higher-layer configuration parameters, such as radio resource control (RRC) parameters. For instance, in a 2-step RA procedure, the terminal device may determine the transmission of a message A (MSGA) on the PUSCH based on RRC higher-layer configuration parameters carried in a system information block (SIB). Furthermore, in a case where the base station side fails to decode the PUSCH for message A during a 2-step RA procedure, the 2-step RA procedure falls back to a 4-step RA procedure. In response to falling back to the 4-step RA procedure, a fallback RAR may schedule the transmission of the message 3 on the PUSCH.

As an example, retransmission resources for the PUSCH may be dynamically scheduled via the PDCCH, or be triggered by configuring a retransmission timer. The retransmission of the PUSCH may correspond to different numbers R of repetition transmissions, for example, R={2, 4, 8, 16, 20}. A smaller number of repetition transmissions typically implies a higher operating signal-to-noise Ratio (SNR), and vice versa.

As an example, in addition to dynamic scheduling, PUSCH transmission and retransmission may also be semi-statically scheduled based on a configured grant (CG). For configured grant type 1, all parameters for PUSCH transmission take effect immediately upon being configured by RRC. For configured grant type 2, RRC configures a portion of the higher-layer parameters for PUSCH transmission, while the remaining parameters are indicated by the activation of a DCI format.

As an example, the DCI may also include resource allocation in the frequency and time domains. For example, the DCI may point to a row index of a table via a time-domain resource indication field. The row corresponding to this index may indicate a slot offset, a start symbol, and the number of symbols. As another example, the DCI may designate a portion of a slot for uplink transmission, and it also supports the possibility that slot resource allocations may be different across different slots. It should be noted that for transmission that may be repeated over a maximum of 8 slots with a same transport block (TB), the transmission resources are not indicated by table-based dynamic signaling, but are instead configured via single RRC signaling.

In summary, how to enhance the uplink capacity and coverage, and improve spectrum utilization efficiency in NTN systems, are issues worthy of research.

In some embodiments, the OCC may be used to improve the capacity and/or spectral efficiency of the system. Exemplarily, a plurality of terminal devices may use the OCC to multiplex the same physical resource block (PRB). That is, a plurality of terminal devices may transmit the TB in the same PRB via the OCC. Each of the terminal devices may transmit the TB on an allocated sub-PRB using a different OCC sequence, in order to generate higher uplink capacity gain and maintain enhanced uplink coverage.

The OCC is a technology that achieves frequency-domain resource multiplexing in a communication system. The OCC is a set of mutually orthogonal codewords, allowing a plurality of users to simultaneously transmit the TB on the same frequency resource without interfering with each other. Specifically, due to the mutual orthogonality of the orthogonal codes, the superimposed signals do not interfere with each other in the frequency domain, thus achieving frequency-domain resource multiplexing for a plurality of users. At a receiver end, the superimposed signal may be separated into original data of each individual user using corresponding demodulation and decoding techniques Exemplarily, the NTN may schedule a plurality of terminal devices to multiplex the same PRB via DCI. Exemplarily, in a multi-user scenario, the OCC may be used for resource allocation among the plurality of terminal devices within the same PRB.

Furthermore, to ensure that the superimposed signal is effectively separated and decoded at the receiver end, appropriate synchronization and channel estimation are required on each PRB to cope with potential time delays and channel fading during transmission.

In some embodiments, the OCC may be a set of Zadoff-Chu (ZC) sequences. ZC sequences are sequences with good orthogonality. Specifically, different orthogonal codes may be acquired by selecting different root indexes and sequence lengths for the ZC sequences.

In some embodiments, the OCC sequences may be determined based on a Hadamard matrix. A Hadamard matrix is a special type of orthogonal matrix where each row is mutually orthogonal to the others. In a communication system, the rows of a Hadamard matrix may be used as orthogonal cover codes. Such a set of codewords may ensure good orthogonality in the frequency domain, such that frequency-domain resource multiplexing is also achieved for the plurality of users.

Taking OCC sequences formed from a Hadamard matrix as an example, after a Hadamard matrix is generated through a recursive construction method, each row may be considered an orthogonal code. The order of the Hadamard matrix determines the number of terminal devices that may be supported. Typically, the order of the matrix is chosen to be a power of 2, such as 2, 4, 8, 16, or the like.

Exemplarily, an OCC based on a length-2 Hadamard matrix is: UE=[x(0) x(1)], wherein UE1=[1, 1] and UE2=[1, −1].

Exemplarily, the OCC sequences based on a length-4 Hadamard matrix may be designed as listed in Table 1.

TABLE 1

| Index | [X(0) X(1) X(2) X(3)] |
|---|---|
| 0 | [+1 +1 +1 +1] |
| 1 | [+1 −1 +1 −1] |
| 2 | [+1 +1 −1 −1] |
| 3 | [+1 −1 −1 +1] |

In accordance with Table 1, indexes 0 to 3 are mapped to UE 1 to UE 4, respectively, wherein UE=[x(0) x(1) x(2) x(3)]. As illustrated in Table 1, the sequences corresponding to the four UEs are UE1=[1, 1, 1, 1], UE2−[1, −1, 1, −1], UE3=[1, 1, −1, −1], and UE4=[1, −1, −1, 1]. Consequently, orthogonality may be achieved for the physical uplink shared channel (PUSCH) when multiplexed in the frequency domain.

The above description has introduced, by way of example for the NTN, a plurality of scenarios characterized by high uplink communication requirements and a plurality of OCC sequences for improving system capacity. Nevertheless, the application of the OCC sequences for enhancing uplink capacity and coverage faces the following issues.

Exemplarily, the number of terminal devices within an NTN system is substantial, while any specific set of OCC sequences is limited in size.

Exemplarily, an OCC sequence may be used by the terminal device for the transmission of a TB. For a transmission of the TB on orthogonal frequency-division multiplexing (OFDM) symbols using an OCC, modulation symbols thereof are to be spreaded for multiple times. Alternatively, a transport block size (TBS) may be represented as N_{info}, which is determined in accordance with the following equation:

$${N}_{info} = {N}_{RR} \cdot R \cdot {Q}_{in} \cdot v ;$$

wherein N_{RE} denotes the number of resource elements (Res), R denotes a code rate, Qₘ denotes a modulation order, and v denotes the number of transmission layers. The modulation order is, for example, an order corresponding to a modulation and coding scheme (MCS).

Based on the TBS determined by the aforementioned formula, N_{RE}·Qₘ·v coded bits are to be extracted from a circular buffer during a rate matching procedure. The multiple spreading of modulation symbols may result in a condition where not all modulation symbols may be mapped to resources, consequently causing a portion of the coded bits to be discarded. In such a scenario, the characteristics of low density parity check (LDPC) coding may be impaired, thereby leading to a decoding failure at a receiver.

Exemplarily, as a plurality of terminal devices are multiplexed together for transmission, it is required that the plurality of terminal devices transmit the TB simultaneously. That is, the start positions of data from the plurality of terminal devices using the OCC for spreading are required to be aligned. However, in a practical transmission system, a plurality of terminal devices transmit uplink data individually based on DCI scheduling, and therefore, alignment thereof needs to be taken into consideration. Furthermore, when applying the OCC in the time domain, a plurality of orthogonal codes used for the OCC are also required to be mutually aligned to ensure that the property of orthogonality is preserved during the application of the OCC at the receiver end.

Therefore, a network device is required to achieve the alignment of both the uplink transmissions of terminal devices and the OCC codes by means of scheduling. For example, a network device is required to ensure that terminal devices associated with a specific OCC length are scheduled for transmission on a particular transmission occasion. However, this is not always readily achievable, particularly when the number of terminal devices to be multiplexed is substantial. Furthermore, in retransmissions of the PUSCH, different terminal devices may have varying requirements for the number of transmission repetitions to satisfy their respective link budgets, which renders such alignment more cumbersome.

It is to be noted that the issues regarding the use of the OCC in an NTN system to increase system capacity or spectral efficiency are merely exemplary. Embodiments of the present disclosure are applicable to any type of scenario that uses the OCC for multiplexing of an uplink transmission resource. Exemplarily, the methods according to the embodiments of the present disclosure are also applicable to a TN to improve uplink transmission efficiency of the PUSCH.

To address a portion of the above-mentioned problems, some embodiments of the present disclosure further provide a method for wireless communication. By the method, a first terminal device may determine, based on first information, a start time-domain position for an uplink transmission using a first OCC sequence. When a plurality of terminal devices respectively perform a plurality of uplink transmissions, the first information is determined in relation to time-domain positions of the plurality of uplink transmissions and/or an OCC sequence set that includes the first OCC sequence, thereby facilitating the alignment of OCC sequences when the plurality of terminal devices respectively perform uplink transmissions based on the OCC sequences.

For ease of understanding, the method according to some embodiments of the present disclosure is described in detail hereinafter with reference to FIG. 4.

The method illustrated in FIG. 4 is performed by a first terminal device. The first terminal device may be one of a plurality of terminal devices that perform resource multiplexing using the OCC.

Referring to FIG. 4, in step S410, the first terminal device determines a first OCC sequence.

The first terminal device may be any type of terminal device or relay as described above, which is not limited herein.

In some embodiments, the first terminal device may be a terminal in a network characterized by a relatively long communication delay. Optionally, the first terminal device may be a terminal device in an NTN system. That is, a serving cell of the first terminal device is an NTN cell. Alternatively, the first terminal device is a terrestrial terminal within an NTN cell. As an example, the first terminal device may be a terminal in a narrowband Internet of things (NB-IoT) system.

As an example, the first terminal device is deployed within a coverage area of a satellite. For example, the first terminal device is an NTN IoT terminal.

In some embodiments, the first terminal device is a communication device performing uplink transmission to a network-side device in any communication system.

The first terminal device may be any terminal in a plurality of terminal devices performing resource multiplexing. That is, the plurality of terminal devices may refer to any number of terminal devices including the first terminal device, which is not limited herein.

In some embodiments, the plurality of terminal devices including the first terminal device may constitute a terminal device group, for example, a first terminal device group. As the plurality of terminal devices belong to a terminal device set, another communication device may communicate wirelessly with the plurality of terminal devices based on the terminal device set.

In some embodiments, the plurality of terminal devices may multiplex the same uplink transmission resource to enhance system capacity. Exemplarily, the uplink transmission resource may be one or more of the PRBs. Exemplarily, the plurality of terminal devices may multiplex the same slot or symbol.

The first OCC sequence may be a sequence within an OCC sequence set corresponding to the first terminal device. The OCC sequence set may include a plurality of sequences that are mutually orthogonal. That is, the plurality of sequences within the OCC sequence set constitute a set of orthogonal codes, which may also be referred to as an orthogonal sequence set.

As an example, the plurality of sequences in the OCC sequence set constitute an OCC sequence set. For example, the plurality of OCC sequences in the OCC sequence set are a set of orthogonal codes selected from an available OCC set, and may also be referred to as a plurality of OCC orthogonal codes.

Optionally, the OCC sequence set may employ the Zadoff-Chu sequences or Hadamard matrix as the orthogonal codes.

Optionally, the OCC sequence set may employ comb-like orthogonal codes, such that the plurality of sequences have a fixed spacing. For example, the plurality of sequences may have a fixed frequency spacing, that is, equidistant in the frequency domain. By virtue of an equispaced design in the frequency domain or the time domain, mutual interference between orthogonal codes used on different subcarriers or time-domain units may be minimized, thereby enhancing system performance.

Optionally, the plurality of sequences within the OCC sequence set may achieve either frequency-domain orthogonality or time-domain orthogonality, which is not limited herein.

As an example, the first OCC sequence may be any OCC sequence from the OCC sequence set.

In some embodiments, the plurality of OCC sequences within the OCC sequence set may be allocated to different terminal devices to support resource multiplexing. Exemplarily, the plurality of OCC sequences may be respectively used by a plurality of terminal devices that includes the first terminal device. Exemplarily, the OCC sequence set is used by a plurality of terminal devices, including the first terminal device, for performing respective uplink transmissions. Consequently, at least two of the plurality of uplink transmissions may multiplex the same time-domain or frequency-domain resources based on mutually orthogonal OCC sequences.

In some embodiments, a length of the OCC sequence set may also indicate the number of mutually orthogonal OCC sequences within the set. As listed in Table 1, an OCC sequence set having a length of 4 includes four OCC sequences, which may be respectively used by four terminal devices.

In some embodiments, an OCC sequence set may be determined based on a plurality of subsets to increase the length of the OCC sequence set, thereby addressing the aforementioned problem of limited availability of OCC sequences. Exemplarily, to serve a larger number of users, the OCC sequence set may be a two-level OCC or a multi-level OCC. In a case where the OCC sequence set is determined based on a plurality of subsets, the OCC sequence set is referred to as a multi-level OCC. In a case where the OCC sequence set is determined based on two subsets, the OCC sequence set is referred to as a two-level OCC.

In some embodiments, a subset used for determining the OCC sequence set may be a set of a plurality of mutually orthogonal sequences. For example, a subset may be OCC1(M) for M users, or may be OCC2(N) for N users, wherein M and N are both positive integers.

In some embodiments, an arbitrary OCC sequence within the OCC sequence set is determined based on at least two subsets from the plurality of subsets. Provided that orthogonality is preserved, the at least two subsets may be subjected to multiplication or other operations. The following description takes a multiplication operation as an example.

As an example, an OCC sequence in the OCC sequence set is determined based on a product of a multiplication (product) between at least two subsets from the plurality of subsets. That is, the OCC sequence set may be a combination of two or more subsets.

As an example, the OCC sequence set may be determined based on two OCC subsets: OCC1(F) and OCC2(T). In a case where the two sequence codes, OCC1 and OCC2, are combined, a spreading factor of FxT may be acquired, thereby enabling a larger number of terminal devices to multiplex the same resources. The spreading factor refers to a ratio of a chip rate to a data rate of the transmission. For example, a plurality of OCCs from OCC1(F) are applied intra-symbol to multiplex F users within the symbol. Utilization of a plurality of OCCs from OCC2(T) over two consecutive symbols or across symbols achieves inter-symbol orthogonality, thereby multiplexing T users between the symbols.

In some embodiments, a plurality of subsets in a multi-level OCC or a two-level OCC may respectively multiplex resources based on different dimensions. The different dimensions may include the time domain and the frequency domain; the time domain, the frequency domain, and the code domain; or the frequency domain and the code domain, which is not limited herein. In a case where the different dimensions include the time domain, spreading may be performed over a very limited time span, thereby enhancing the system performance in scenarios such as the presence of a carrier frequency offset (CFO).

As an example, in a case where the plurality of subsets includes a first subset and a second subset, a plurality of OCC sequences in the first subset corresponds to a plurality of frequency-domain units within the same time-domain unit, and a plurality of OCC sequences in the second subset correspond to a plurality of time-domain units within the same frequency-domain unit. In a case where the time-domain unit is a symbol, the first subset may achieve intra-symbol multiplexing, and the second subset may achieve inter-symbol multiplexing.

As an example, the plurality of time-domain units may be a plurality of symbols, a plurality of slots, or a plurality of other time-domain units.

As an example, the plurality of time-domain units to which the OCC sequence set is applied may be consecutive, which facilitates resource allocation and indication.

As an example, the plurality of time-domain units to which the OCC sequence set is applied may be non-consecutive, which enables more flexible resource scheduling.

As an example, the plurality of frequency-domain units may be a plurality of carriers, a plurality of frequency bands, or a plurality of other frequency-domain units.

As an example, the plurality of frequency-domain units to which the OCC sequence set is applied may be consecutive, which facilitates resource allocation and indication.

As an example, the plurality of frequency-domain units to which the OCC sequence set is applied may be non-consecutive, which enables more flexible resource scheduling.

In some embodiments, a plurality of terminal devices may periodically use a portion of the OCC sequences from the OCC sequence set over the plurality of frequency-domain units. When the number of resources in the frequency domain exceeds the number of OCC sequences corresponding to different frequency-domain units, the OCC sequences may be applied periodically.

As an example, an OCC sequence set may be periodically applied to the plurality of frequency-domain units and/or the plurality of time-domain units.

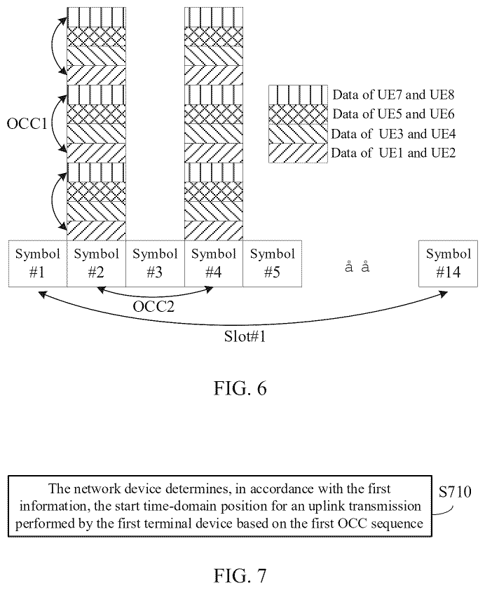

For ease of understanding, resource multiplexing for a plurality of UEs is exemplarily illustrated hereinafter with reference to FIG. 5 and FIG. 6, taking a two-level OCC as an example. In FIG. 5 and FIG. 6, the two-level OCC includes OCC1(4) and OCC2(2); that is, F is 4 and T is 2. The time-domain units for applying the two-level OCC are two symbols within slot #1. Slot #1 includes 14 symbols, namely symbol #1 to symbol #14.

As illustrated in FIG. 5 and FIG. 6, OCC1(4) corresponds to four frequency-domain units within a same time-domain unit, and OCC2(2) corresponds to two time-domain units within a same frequency-domain unit. A combination scheme of OCC1(4) and OCC2(2) may achieve a multiplexing capability for eight UEs, wherein the eight UEs are UE 1 to UE 8. The eight UEs may perform data transmission on corresponding resources based on a combination of OCC1(4) and OCC2(2).

In FIG. 5, the two time-domain units corresponding to OCC2(2) are consecutive symbols #3 and #4, whereas in FIG. 6, the two time-domain units corresponding to OCC2(2) are non-consecutive symbols #2 and #4. OCC1(4) is periodically used in the frequency domain across different frequency-domain units.

In some embodiments, an uplink transmission performed by the first terminal device using the first OCC sequence may be referred to as a first uplink transmission. The first uplink transmission may include transmitting a first TB. That is, the first uplink transmission may include an uplink transmission of the first TB.

As known from the above description, multiple spreading of modulation symbols may result in a portion of coded bits being discarded. To mitigate or prevent this situation, the spreading condition may be taken into account during the calculation of a TBS and during rate matching. As an example, a TBS of the first TB is determined based on a spreading factor corresponding to the first uplink transmission. As another example, the number of coded bits from a circular buffer needs to take the spreading factor into consideration.

As a further example, the TBS or the number of coded bits from the circular buffer may be divided by the spreading factor. Exemplarily, the TBS is a quotient of an initial TBS size and the spreading factor. When the spreading factor is N_{SF}, a formula for the calculation of the TBS may be N_{info}=N_{RE}·R·Qₘ·v/N_{SF}. Exemplarily, when the spreading factor is N_{SF}, the number of coded bits to be retrieved from the circular buffer may be N_{RE}·Qₘ·v/N_{SF}.

In some embodiments, when the first TB is transmitted on a first resource, the spreading factor is determined based on a length of the OCC sequence set and/or the number of terminal devices multiplexing the first resource. The length of the OCC sequence set is as described above.

As an example, the spreading factor is equal to the number of terminal devices multiplexing the first resource or the length of the OCC sequence set.

As another example, the spreading factor is the length of the OCC sequence set divided by the number of time-domain units to which the OCC sequence set is applied.

In some embodiments, in a case where the TBS or the number of coded bits is reduced, the throughput may be affected. Optionally, various solutions may be employed to maintain the same throughput. For example, a TB may be partitioned into smaller TBs. As another example, N_{RE} may be increased. As a further example, for an OCC within the OFDM symbol, a higher-order MCS may be used for modulation and coding. For inter-symbol time-domain OCC, the number of OFDM symbols upon OCC spreading may also be scaled based on the length of the OCC sequence set.

The first terminal device may determine the first OCC sequence based on an indication. To enable orthogonal transmission for a plurality of terminal devices on the same time-frequency resources by using the OCC, it is required to introduce a method for indicating OCC operations to the respective terminal devices. Exemplarily, a network device may instruct or manage the selection of an OCC sequence by a terminal device, and schedule a plurality of terminal devices to perform transmission using different orthogonal codes.

In some embodiments, the first terminal device may receive third information from the network device. The third information is configured for the first terminal device to determine the first OCC sequence. Hereinafter, the network device is described in detail with reference to FIG. 7.

As an example, the third information may directly indicate the first OCC sequence. In a case where the third information is configured to indicate the first OCC sequence, the first terminal device may directly determine a usable first OCC sequence therefrom.

As another example, the third information may indirectly indicate the first OCC sequence. The first terminal device may determine (i.e., select) the first OCC sequence from an OCC sequence set based on the third information. Exemplarily, the third information may include an OCC sequence set and an index indication, and the first terminal device may determine its corresponding first OCC sequence from a plurality of OCC sequences based on the index indication. Exemplarily, the third information may include an OCC sequence set and a selection strategy, and the first terminal device may select the first OCC sequence based on the selection strategy.

As an example, the third information may be conveyed in DCI. Exemplarily, in a case where the first terminal device is configured to perform an uplink transmission based on the OCC, its corresponding first OCC sequence may be dynamically indicated in the DCI.

Exemplarily, the third information may be conveyed in a new DCI field within the DCI or carried in a conventional DCI field. That is, a network device may add a new field to the DCI to indicate the third information, or may multiplex a conventional field to indicate the third information.

In some embodiments, when an uplink transmission performed by the first terminal device includes a retransmission of the PUSCH, the network device may configure the first OCC sequence for the first terminal device based on a plurality of pieces of information. The plurality of pieces of information may include: a PUSCH repetition type, a slot offset, a start symbol relative to a start of a slot, the number of consecutive symbols allocated to the PUSCH beginning from the start symbol, a mapping type (mapping type A/B), the number of PUSCH repetitions, and the number of slots corresponding to a TBS.

Optionally, the plurality of pieces of information may be used to determine a PUSCH resource allocation, wherein the mapping type A/B is used to determine different allocation results.

In some embodiments, the network device may manage the multiplexing of transmission resources by a plurality of terminal devices based on capability information or indication information of the terminal devices. Exemplarily, the network device may, upon determining that a terminal device supports an OCC functionality, configure an OCC sequence therefor.

As an example, the terminal device may transmit second information to the network device. The second information is configured to indicate whether the first terminal device supports the uplink transmission based on the OCC sequence. In a case where the second information indicates that the first terminal device supports performing the uplink transmission based on the OCC sequence, the network device performs configuration and provides an indication thereof via the third information. In a case where the second information indicates that the first terminal device does not support performing the uplink transmission based on the OCC sequence, the network device excludes the first terminal device from consideration during OCC management.

As an example, the second information may be capability information of the first terminal device.

As another example, the second information may be information for enabling or disabling a control function for an OCC feature of the first terminal device. Exemplarily, a control function for the OCC feature of the first terminal device may be enabled or disabled via radio resource control (RRC).

Continuing to refer to FIG. 4, in step S420, the first terminal device determines, in accordance with the first information, a start time-domain position for an uplink transmission based on the first OCC sequence. The start time-domain position may be a slot or a symbol within a slot, which is not limited herein.

The uplink transmission based on the first OCC sequence may be an uplink transmission of a plurality of channels or a plurality of signals. The plurality of channels are, for example, the PUSCHs as described above. The uplink transmission may include an initial transmission and a retransmission. The plurality of signals are, for example, a plurality of uplink reference signals.

The uplink transmission based on the first OCC sequence may be used to transmit a plurality of types of data, which is not limited herein.

As an example, the first uplink transmission may be an initial transmission and/or one or more repetition transmissions from the PUSCH.

As another example, a plurality of uplink transmissions, including the first uplink transmission may be uplink transmissions respectively performed by a plurality of terminal devices based on different OCC sequences. The plurality of uplink transmissions may be transmissions of a same type of channel or signal, or may be transmissions of different types of channels or signals.

Exemplarily, the plurality of uplink transmissions may be repetition transmissions from the PUSCH respectively performed by a plurality of terminal devices.

Exemplarily, the plurality of uplink transmissions may include repetition transmissions from the PUSCH, or may include transmissions of uplink reference signals.

In some embodiments, the network device, when allocating transmission resources and OCC sequences to a plurality of terminal devices, may configure a plurality of terminal devices having a same transmission type to multiplex the same resources, thereby enhancing resource utilization.

As an example, in a case where a plurality of uplink transmissions respectively include PUSCH repetition transmissions from a plurality of terminal devices, the PUSCH repetition transmissions performed by the plurality of terminal devices correspond to a same number of repetitions. That is, the plurality of terminal devices all perform PUSCH transmissions with the same number of repetitions. By multiplexing PUSCH transmissions having the same number of repetitions, resource utilization may be maximized.

The start time-domain position for the uplink transmission based on the first OCC sequence refers to a start time-domain position at which the first terminal device, together with other terminal devices, multiplexes a same resource based on OCC sequences to perform uplink transmissions. That is, when the first terminal device performs an uplink transmission, not all uplink resources thereof are multiplexed based on the OCC sequences. Accordingly, the first terminal device is required to determine a time at which to start an uplink transmission using the first OCC sequence. The network device is also required to determine the time at which different terminal devices are to respectively use different OCC sequences, so as to facilitate decoding.

The network device may also determine, in accordance with the first information, the start time-domain position for an uplink transmission performed by the first terminal device based on the first OCC sequence, as illustrated in step S710 in FIG. 7. The network device may be any of the network devices as described above or any device on the network side. In some embodiments, the network device includes a satellite in an NTN system, and the first terminal device is a terminal device that communicates with the network device via the satellite. Exemplarily, in a case where a base station is deployed on a satellite, the first terminal device communicates directly with the base station deployed on the satellite. Exemplarily, in a case where a satellite functions as a relay, the first terminal device communicates with a terrestrial network device via the satellite.

Exemplarily, in a case where the network device includes a satellite, the first terminal device is located within a service area of the satellite at a current instant to receive third information via the satellite. Alternatively, a plurality of terminal devices in a first terminal device group are all located within the service area of the satellite at a current instant to receive, via the satellite, indication information corresponding to each of the terminal devices.

In some embodiments, the network device, acting as a receiver end for an uplink transmission, may determine a time domain for using the OCC sequence by a plurality of terminal devices in accordance with the first information respectively corresponding to the plurality of terminal devices, thereby enabling decoding of received data.

The first information may be respectively used by the first terminal device and the network device to determine the start time-domain position for the uplink transmission using the first OCC sequence. As an example, the first information may also be used by the first terminal device and the network device to determine a period of use for the first OCC sequence.

In some embodiments, the first information may indicate a reference time for determining the start time-domain position. The reference time may also be referred to as a reference timing. In a case where a plurality of terminal devices determine a start time-domain position for using an OCC sequence based on a same reference time, reception at a receiver end may be facilitated.

In some embodiments, the first information may indicate a transmission type or a transmission parameter corresponding to the start time-domain position. In a case where the first uplink transmission includes repetition transmissions from the PUSCH, the first information may indicate the number of repetition transmissions corresponding to the start time-domain position.

The first information may be associated with a timing of an OCC sequence set and/or a plurality of uplink transmissions, to facilitate a determination, by a plurality of terminal devices, of a time for performing an uplink transmission using an OCC sequence based on a same reference time. Exemplarily, in a case where a plurality of terminal devices are scheduled to multiplex a same resource for an uplink transmission, a network device is only required to ensure that a start time for using an OCC sequence is aligned with a reference timing.

As an example, the first information may be associated with a timing of the OCC sequence set to facilitate a determination by the first terminal device of a time for OCC utilization. The timing of the OCC sequence set may be determined based on configuration of a cell or based on configuration of the OCC sequence set.

As an example, the first information may be associated with a plurality of uplink transmissions. In a possible implementation, the plurality of uplink transmissions include the first uplink transmission, and the first information may include configuration parameters of the first uplink transmission. In another possible implementation, the first information may be determined based on the time-domain positions of the plurality of uplink transmissions. The time-domain positions may include a start time, a duration, or an end time of the plurality of uplink transmissions. The first information may include a specific parameter from a plurality of time parameters, which is used by a plurality of terminal devices to align a reference timing.

In some embodiments, the first information may include one or more of the following: the number of PUSCH repetition transmissions (number of repetitions); a first timing related to an OCC sequence for a serving cell of the first terminal device; a second timing corresponding to an OCC sequence set; and a start time of any uplink transmission in a plurality of uplink transmissions. In a case where the first uplink transmission includes PUSCH repetition transmissions, the first information includes the number of repetition transmissions.

As an example, the number of PUSCH repetition transmissions may be used to determine an uplink transmission that uses the first OCC sequence.

As another example, the first timing related to an OCC sequence within the serving cell may be a common OCC timing within the cell. For instance, after a cell-specific OCC timing T1 is introduced, each terminal device using OCC is required to align a timing of its OCC operation with the common, specific OCC timing of the cell. Consequently, when a network device schedules the first terminal device for transmission, it is only required to ensure that a start time of a repetition is aligned with the first timing, irrespective of when other terminal devices scheduled on the same resource commence their PUSCH repetition transmissions.

In some embodiments, the first timing is determined based on the number of repetition transmissions for some or all of uplink transmissions within the serving cell and/or ephemeris parameters of a satellite corresponding to the serving cell. Exemplarily, T1 may be determined based on the number of transmissions, or may be configured based on NTN ephemeris parameters. For instance, T1 is determined based on a maximum number of repetition transmissions for some or all of uplink transmissions within the serving cell. As another example, T1 is determined based on a service time of a satellite.

In some embodiments, a start time of an OCC sequence set is determined based on the first timing, and the start time-domain position is determined based on the first timing and a first offset value. For example, the start time of the OCC sequence set containing the first OCC sequence is the first timing. A start time-domain position for an uplink transmission by the first terminal device using the first OCC sequence is then a sum of the first timing and the first offset value.

As another example, a second timing corresponding to an OCC sequence set may be a dedicated OCC timing for a group of terminal devices. For example, a group of terminal devices correspond to a dedicated OCC timing T2, and an uplink transmission of each of the terminal devices in the group is required to be aligned with the second timing. That is, when a network device schedules the group of terminal devices for transmission, it is only required to ensure that a start time of a repetition is aligned with the second timing. Even though all terminal devices scheduled for transmission together have timing offsets with respect to the second timing, it may still be ensured that the terminal devices are capable of multiplexing resources based on the OCC.

In some embodiments, the start time of the OCC sequence set is determined based on the second timing, and the start time-domain position is determined based on the second timing and a second offset value. For instance, a start time of the first OCC sequence used by the first terminal device is the second timing. A start time-domain position for an uplink transmission by the first terminal device using the first OCC sequence is accordingly a sum of the second timing and the second offset value.

In some embodiments, the second timing may be identical to a start time of an uplink transmission by any terminal device in the plurality of terminal devices. For example, when the plurality of uplink transmissions include PUSCH repetition transmissions, the any terminal device may be the terminal device having a minimum or a maximum number of repetitions.

In some embodiments, within a time domain corresponding to the first offset value or the second offset value, the first terminal device does not perform an uplink transmission based on any OCC sequence from the OCC sequence set. That is, within the time domain corresponding to the first offset value or the second offset value, the first terminal device does not perform an uplink transmission, or an uplink transmission thereof is not multiplexed with other terminal devices on a same resource based on the OCC. For example, within the time domain corresponding to the first offset value or the second offset value, any OCC sequence from the OCC sequence set is not used for an uplink transmission by the first terminal device.

As an example, a start time of any uplink transmission in the plurality of uplink transmissions may refer to a start time of any of the plurality of uplink transmissions that are multiplexing a same resource. During scheduling, a network device may set an OCC-related timing to be identical to a time of any one of the uplink transmissions.

In some embodiments, the any uplink transmission may be the uplink transmission corresponding to the terminal device having a minimum number of repetition transmissions.

In some embodiments, the any uplink transmission may be the uplink transmission corresponding to the terminal device having a maximum number of repetition transmissions.

In some embodiments, the first information respectively corresponding to a plurality of terminal devices may be identical or may be different.

In some embodiments, when a network device performs DCI scheduling, the network device may schedule all multiplexed terminal devices to transmit at a same time. That is, a network device may also directly schedule a plurality of terminal devices to commence utilization of OCC sequences at a same time-domain position.

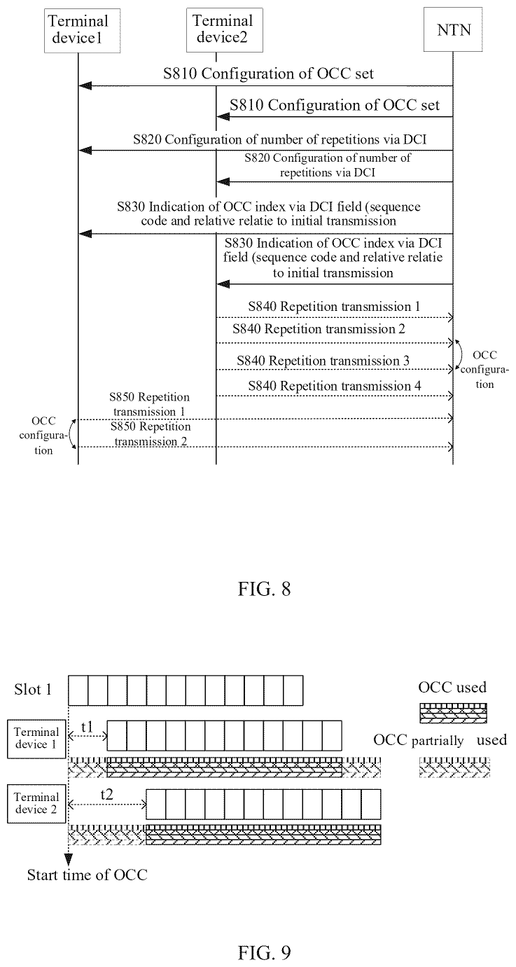

The foregoing description, with reference to FIG. 6 and FIG. 7, has respectively described a method for a first terminal device and a network device to determine time for using an OCC based on first information, thereby ensuring consistency between the start time-domain positions determined by the terminal device and the network device. The first information may be determined based on an actual application scenario. The first information may include any one of the aforementioned pieces of information, or any combination thereof, which is not limited herein. For ease of understanding, the following, with reference to FIG. 8 to FIG. 10, provides an exemplary illustration of the first information in a plurality of scenarios.

In some embodiments, when the first uplink transmission includes PUSCH repetition transmissions, the repetition transmissions may be a portion of the total PUSCH repetitions. That is, a network device may schedule only a portion of the PUSCH repetition transmissions from the first terminal device to share a specific resource with other terminal devices. For an OCC with scheduled repetition transmissions, configuration information from a network device may pertain only to a portion of the repetition transmissions on a multiplexed resource, which facilitates a more flexible application of the OCC for multiplexing.

As an example, when the first information includes the number of PUSCH repetition transmissions, a start time-domain position for an uplink transmission using the first OCC sequence may be related to the number of repetition transmissions.

In a possible implementation, an OCC sequence set may include N OCC sequences, N being a positive integer, and the number of PUSCH repetition transmissions may be M, M being a positive integer. In a case where M is greater than N, the first OCC sequence is used for any N consecutive repetition transmissions in the M repetition transmissions, and the start time-domain position is determined based on a time-domain position of a first repetition transmission of the any N consecutive repetition transmissions. For example, when N is 2, the start time-domain position may be a start time-domain position of a first retransmission in any two consecutive repetition transmissions.

In another possible implementation, when M is equal to or less than N, the first OCC sequence is used for the M repetition transmissions, and the start time-domain position is a start time-domain position of a first repetition transmission in the M repetition transmissions. For example, in a case where a length of the OCC sequence set is 2 and the first terminal device is scheduled for 2 repetitions, the 2 repetition transmissions from the first terminal device are entirely covered by the OCC.

As an example, the start time-domain position may be determined based on a position of an initial PUSCH transmission (which may also be referred to as an initial transmission) and an offset index. The offset index may also be referred to as an offset slot index. Exemplarily, an offset index index_{offset} is introduced, wherein the offset index may indicate a position of a PUSCH repetition transmission, at which the first terminal device commences use of the first OCC sequence, relative to an initial PUSCH transmission.

Exemplarily, the first uplink transmission includes a PUSCH transmission (i.e., the first OCC sequence is used for the PUSCH transmission), a start time-domain position of the PUSCH transmission is determined based on an offset index index_{offset} corresponding thereto, and the offset index may be determined based on the first information.

Exemplarily, based on configuration of the first OCC sequence, a start time-domain position K_{s_occ} for an uplink transmission by the first terminal device using the first OCC sequence may be expressed as:

$${K}_{s \_ occ} = ⌊ n \cdot \frac{{2}^{{μ}_{PUSCH}}}{{2}^{{μ}_{PDCCH}}} ⌋ + {K}_{2} + {K}_{offset} \cdot \frac{{2}^{{μ}_{PUSCH}}}{{2}^{{μ}_{{K}_{offset}}}} + {index}_{offset} ;$$

wherein n represents a slot scheduled by DCI, μ_{PUSCH} and μ_{PDCCH} respectively represent a subcarrier spacing configuration for the PUSCH and a subcarrier spacing configuration for a PDCCH, K₂ represents a dataset parameter of the PUSCH, K_{offset} represents an offset parameter, and μ_{K}_{_{offset}} represents a subcarrier spacing configuration related to a frequency range.

In some embodiments, K₂ may be used to determine a start slot of an allocated PUSCH, and K_{s_occ} may be a slot where the first OCC sequence begins.

In some embodiments, K_{offset} is a parameter configured by a higher layer. For frequency range 1, a value of μ_{K}_{_{offset}} is 0.

For ease of understanding, the following, with reference to FIG. 8, provides an exemplary illustration using an example where an OCC sequence is used for PUSCH repetition transmissions. FIG. 8 is presented from a perspective of an interaction between the two terminal devices and the NTN. The two terminal devices are terminal device 1 and terminal device 2. NTN may represent a network-side device of an NTN, for example, a satellite.

Referring to FIG. 8, in step S810, terminal device 1 and terminal device 2 receive configuration of an OCC set from the NTN. Herein, the OCC set is an OCC sequence set. The NTN may perform the transmission via RRC signaling.

In step S820, the NTN configures the number of repetitions for terminal device 1 and terminal device 2 via DCI. As illustrated in FIG. 8, the number of repetitions for terminal device 1 is 2, and the number of repetitions for terminal device 2 is 4.

In step S830, the NTN indicates an OCC index via a DCI field. The DCI field may further indicate a code sequence and an offset relative to the initial transmission.

In step S840, terminal device 2 performs the scheduled four repetitions, namely, repetition transmission 1 to repetition transmission 4. Therein, only repetition transmission 2 and repetition transmission 3 are transmitted using the OCC sequence from the OCC configuration.

In step S850, terminal device 1 performs the scheduled two repetitions based on the OCC configuration, namely, repetition transmission 1 and repetition transmission 2.

As illustrated in FIG. 8, terminal device 1 is scheduled for two repetitions, and terminal device 2 is scheduled for four repetitions. The OCC configuration has a length of 2. As illustrated in FIG. 8, the OCC sequence set of a length of 2 is used only for the second and third repetition transmissions from terminal device 2, whereas the two scheduled repetitions of terminal device 1 are entirely covered by the OCC.

In some embodiments, for terminal device 2, the two repetition transmissions using OCC may alternatively be any other two consecutive repetition transmissions in the four repetition transmissions, for example, the first and second repetition transmissions; and still for example, the third and fourth repetition transmissions.

The foregoing description, with reference to FIG. 8, has illustrated the application of OCC sequences for PUSCH repetitions. Irrespective of whether for PUSCH repetitions, to facilitate the scheduling by the network device of an appropriate application of OCC sequences in an uplink transmission, a timing related to the OCC may be introduced. As aforementioned, the first timing may be a cell-common timing, whereas the second timing is a timing dedicated to an OCC sequence set.

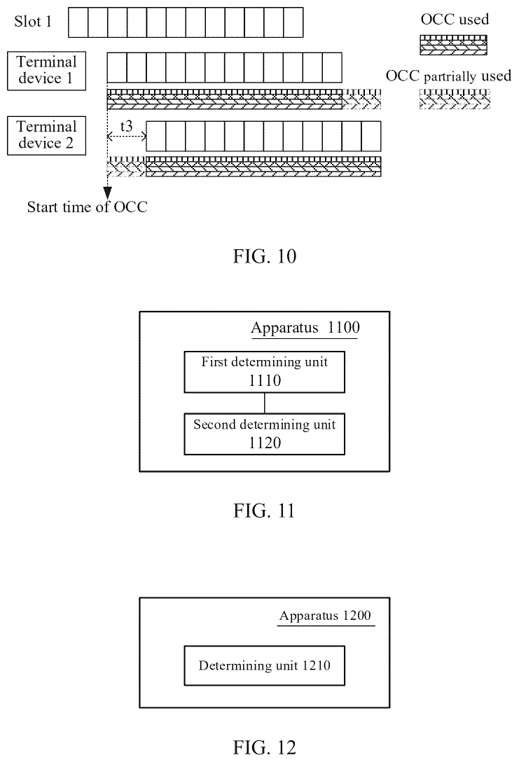

For ease of understanding, the following, with reference to FIG. 9 and FIG. 10, provides an exemplary illustration of use of two types of reference timings. The reference timing in FIG. 9 is the first timing, and the reference timing in FIG. 10 is the second timing as described above. In FIG. 9 and FIG. 10, the two terminal devices performing uplink transmissions are terminal device 1 and terminal device 2. A length of the OCC configuration is 4.

Referring to FIG. 9, a slot 1 is designated as the start of a cell-specific OCC timing (the first timing). Each terminal device within the NTN cell based on OCC sequence multiplexing is required to be aligned with the timing T1. For example, a time for an uplink transmission by terminal device 1, subsequent to multiplexing based on a corresponding OCC sequence, is: T1+t1. Still for example, a time for an uplink transmission by terminal device 2, subsequent to multiplexing based on its corresponding OCC sequence, is: T1+t2. Accordingly, a network device may, based on the time difference, ascertain the time resources within which the plurality of terminal devices are multiplexed together.

Referring to FIG. 10, the second timing is determined based on the uplink transmission corresponding to terminal device 1. That is, the uplink transmission corresponding to terminal device 1 is used to determine the OCC timing for other uplink transmissions. For instance, a time for the uplink transmission by terminal device 1, subsequent to multiplexing based on its corresponding OCC sequence, is T2; and a time for the uplink transmission by terminal device 2, subsequent to multiplexing based on its corresponding OCC sequence, is: T2+t3.

In FIG. 9 and FIG. 10, a “utilization of OCC” indicates that all four OCC sequences are used, or that an OCC sequence corresponding to a terminal device is used. A “partial utilization of OCC” indicates that a portion of the four OCC sequences is used, or that an OCC sequence corresponding to a terminal device is not used.

The method embodiments of the present disclosure have been described in detail with reference to FIG. 1 to FIG. 10. Hereinafter, some apparatus embodiments of the present disclosure are described in detail with reference to FIG. 11 to FIG. 13. It should be understood that the description of the apparatus embodiments corresponds to the description of the method embodiments, such that the parts that are not described in detail may be referred to the preceding method embodiments.

FIG. 11 is a schematic block diagram of an apparatus 1100 for satellite communication in an NTN system according to some embodiments of the present disclosure. The apparatus 1100 may be any first terminal device as described above. The apparatus 1100 as illustrated in FIG. 11 includes a first determining unit 1110 and a second determining unit 1120.

The first determining unit 1110 is configured to determine a first OCC sequence.

The determining unit 1120 is configured to determine, in accordance with first information, a start time-domain position for an uplink transmission based on a first OCC sequence, wherein the first OCC sequence is any OCC sequence in an OCC sequence set, wherein the OCC sequence set is configured for a plurality of terminal devices including the first terminal device to respectively perform a plurality of uplink transmissions, and the first information is associated with timing of the OCC sequence set and/or the plurality of uplink transmissions.

In some embodiments, the OCC sequence set is determined based on a plurality of subsets, and any OCC sequence in the OCC sequence set is determined based on a product of at least two subsets in the plurality of subsets.

In some embodiments, the plurality of subsets include a first subset and a second subset, wherein a plurality of OCC sequences in the first subset correspond to a plurality of frequency-domain units within a same time-domain unit, and a plurality of OCC sequences in the second subset correspond to a plurality of time-domain units within a same frequency-domain unit.

In some embodiments, the uplink transmission performed by the first terminal device using the first OCC sequence is a first uplink transmission, wherein the first uplink transmission includes transmission of a first TB, a size of the first TB being determined based on a spreading factor corresponding to the first uplink transmission.

In some embodiments, the first TB is transmitted over a first resource, and the spreading factor is determined based on at least one of a length of the OCC sequence set or a number of terminal devices multiplexing the first resource.

In some embodiments, the apparatus 1100 further includes a transmitting unit. The transmitting unit is configured to transmit second information to the network device, wherein the second information is configured to indicate whether the first terminal device supports an uplink transmission based on an OCC sequence.

In some embodiments, the apparatus 1100 further includes a receiving unit. The receiving unit is configured to receive third information from the network device, wherein the third information is carried in DCI, and the third information is configured to indicate the first OCC sequence, or is configured for the first terminal device to determine the first OCC sequence in the OCC sequence set.

In some embodiments, the plurality of uplink transmissions include PUSCH repetition transmissions from the plurality of terminal devices, wherein the PUSCH repetition transmissions from the plurality of terminal devices correspond to a same number of repetition transmissions.

In some embodiments, the first information includes one or more of the following: the number of PUSCH repetition transmissions; a first timing related to an OCC sequence for a serving cell of the first terminal device; a second timing corresponding to an OCC sequence set; and a start time of any uplink transmission in a plurality of uplink transmissions.

In some embodiments, the OCC sequence set includes N OCC sequences, N being a positive integer, and the number of repetition transmissions is M, M being a positive integer, wherein in a case where M is greater than N, the first OCC sequence is used for any N consecutive repetition transmissions in the M repetition transmissions, and the start time-domain position is determined based on a time-domain position of a first repetition transmission of the any N consecutive repetition transmissions.

In some embodiments, a start time of the OCC sequence set is determined based on the first timing or the second timing, and the start time-domain position is determined based on the first timing and a first offset value, or the start time-domain position is determined based on the second timing and a second offset value.

In some embodiments, the first timing is determined based on the number of repetitions of some or all of uplink transmissions within the serving cell and/or ephemeris parameters of a satellite corresponding to the serving cell.

In some embodiments, the first OCC sequence is used for PUSCH transmission, wherein a start time-domain position of the PUSCH transmission is determined based on an offset index corresponding to the PUSCH transmission, the offset index being determined based on the first information.

In some embodiments, the start time-domain position K_{s_occ} is:

$${K}_{s \_ occ} = ⌊ n \cdot \frac{{2}^{{μ}_{PUSCH}}}{{2}^{{μ}_{PDCCH}}} ⌋ + {K}_{2} + {K}_{offset} \cdot \frac{{2}^{{μ}_{PUSCH}}}{{2}^{{μ}_{{K}_{offset}}}} + {index}_{offset} ;$$

wherein index_{offset} represents the offset index, n represents a slot scheduled by downlink control information (DCI), μ_{PUSCH} and μ_{PDCCH} respectively represent a subcarrier spacing configuration for the PUSCH and a subcarrier spacing configuration for a physical downlink control channel (PDCCH), K₂ represents a dataset parameter of the PUSCH, K_{offset} represents an offset parameter, and μ_{K}_{_{offset}} represents a subcarrier spacing configuration related to a frequency range.

FIG. 12 is a schematic block diagram of another apparatus 1200 for wireless communication according to some embodiments of the present disclosure. The apparatus 1200 may be any network device as described above. The apparatus 1200 as illustrated in FIG. 12 includes a determining unit 1210.

The determining unit 1210 is configured to determine, in accordance with first information, a start time-domain position for an uplink transmission performed by a first terminal device based on a first OCC sequence, wherein the first OCC sequence is any OCC sequence in an OCC sequence set, wherein the OCC sequence set is configured for a plurality of terminal devices including the first terminal device to respectively perform a plurality of uplink transmissions, and the first information is associated with timing of the OCC sequence set and/or the plurality of uplink transmissions.

In some embodiments, the OCC sequence set is determined based on a plurality of subsets, and any OCC sequence in the OCC sequence set is determined based on a product of at least two subsets in the plurality of subsets.

In some embodiments, the plurality of subsets include a first subset and a second subset, wherein a plurality of OCC sequences in the first subset correspond to a plurality of frequency-domain units within a same time-domain unit, and a plurality of OCC sequences in the second subset correspond to a plurality of time-domain units within a same frequency-domain unit.

In some embodiments, the uplink transmission performed by the first terminal device using the first OCC sequence is a first uplink transmission, wherein the first uplink transmission includes transmission of a first TB, a size of the first TB being determined based on a spreading factor corresponding to the first uplink transmission.

In some embodiments, the first TB is transmitted over a first resource, and the spreading factor is determined based on at least one of a length of the OCC sequence set or a number of terminal devices multiplexing the first resource.

In some embodiments, the apparatus 1200 further includes a receiving unit. The transmitting unit is configured to receive second information from the first terminal device, wherein the second information is configured to indicate whether the first terminal device supports an uplink transmission based on an OCC sequence.

In some embodiments, the apparatus 1200 further includes a transmitting unit. The transmitting unit is configured to transmit third information to the first terminal device, wherein the third information is carried in DCI, and the third information is configured to indicate the first OCC sequence, or is configured for the first terminal device to determine the first OCC sequence in the OCC sequence set.

In some embodiments, the plurality of uplink transmissions include PUSCH repetition transmissions from the plurality of terminal devices, wherein the PUSCH repetition transmissions from the plurality of terminal devices correspond to a same number of repetition transmissions.

In some embodiments, the first information includes one or more of the following: the number of PUSCH repetition transmissions; a first timing related to an OCC sequence for a serving cell of the first terminal device; a second timing corresponding to an OCC sequence set; and a start time of any uplink transmission in a plurality of uplink transmissions.

In some embodiments, the OCC sequence set includes N OCC sequences, N being a positive integer, and the number of repetition transmissions is M, M being a positive integer, wherein in a case where M is greater than N, the first OCC sequence is used for any N consecutive repetition transmissions in the M repetition transmissions, and the start time-domain position is determined based on a time-domain position of a first repetition transmission of the any N consecutive repetition transmissions.

In some embodiments, a start time of the OCC sequence set is determined based on the first timing or the second timing, and the start time-domain position is determined based on the first timing and a first offset value, or the start time-domain position is determined based on the second timing and a second offset value.

In some embodiments, the first timing is determined based on the number of repetitions of some or all of uplink transmissions within the serving cell and/or ephemeris parameters of a satellite corresponding to the serving cell.

In some embodiments, the first OCC sequence is used for PUSCH transmission, wherein a start time-domain position of the PUSCH transmission is determined based on an offset index corresponding to the PUSCH transmission, the offset index being determined based on the first information.

In some embodiments, the start time-domain position K_{s_occ} is:

$${K}_{s \_ occ} = ⌊ n \cdot \frac{{2}^{{μ}_{PUSCH}}}{{2}^{{μ}_{PDCCH}}} ⌋ + {K}_{2} + {K}_{offset} \cdot \frac{{2}^{{μ}_{PUSCH}}}{{2}^{{μ}_{{K}_{offset}}}} + {index}_{offset} ;$$

wherein index_{offset} represents the offset index, n represents a slot scheduled by DCI, μ_{PUSCH} and μ_{PDCCH} respectively represent a subcarrier spacing configuration for the PUSCH and a subcarrier spacing configuration for a PDCCH, K₂ represents a dataset parameter of the PUSCH, K_{offset} represents an offset parameter, and μ_{K}_{_{offset}} represents a subcarrier spacing configuration related to a frequency range.

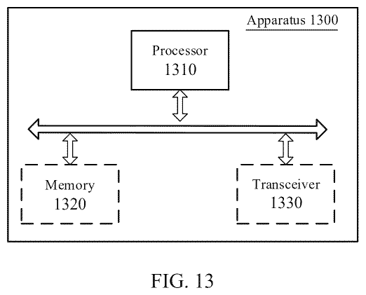

FIG. 13 is a schematic structural diagram of a communication device 1300 according to some embodiments of the present disclosure. The dotted lines in FIG. 13 indicate that the unit or module is optional. The communication device 1300 may be employed to perform the method according to the above method embodiments. The communication device 1300 may be a chip, a terminal device, or a network device.

The communication device 1300 may include one or more processors 1310. The processor 1310 may support implementation of the method according to the above method embodiments by the communication device 1300. The processor 1310 may be a general-purpose processor or an application-specific processor. For example, the processor may be a central processing unit (CPU). The processor may be a general processor, a digital signal processor (DSP), an application-specific integrated circuit (ASIC), a field-programmable gate array (FPGA) or another programmable logic device, a discrete gate or transistor logic device, or a discrete hardware component, or the like. The general-purpose processor may be a microprocessor or any customary processor or the like.

The communication device 1300 may further include one or more memories 1320. The memory 1320 has stored thereon a program that is executable by the processor 1310 to cause the processor 1310 to perform the method described in the above method embodiments. The memory 1320 may be separate from the processor 1310 or integrated within the processor 1310.

The communication device 1300 may also include a transceiver 1330. The processor 1310 may communicate with other devices or chips by the transceiver 1330. For example, the processor 1310 may communicate (transmit and receive) data with other devices or chips by the transceiver 1330.

Some embodiments of the present disclosure further provide a computer-readable storage medium configured to store one or more programs. The computer-readable storage medium may be applied to a terminal device or a network device according to the embodiments of the present disclosure, and the one or more programs cause a computer to perform the method performed by the terminal device or the network device according to the respective embodiments of the present disclosure.

The computer-readable storage medium may be any available medium that is accessible or a data storage device such as a server, a data center or the like integrated with one or a plurality of available media. The available medium may be a magnetic medium, for example, a floppy disk, a hard disk or a magnetic tape, an optical medium, for example, a digital versatile disc (DVD), or a semiconductor medium, for example, a solid state disk (SSD) or the like.

Some embodiments of the present disclosure further provide a computer program product. The computer program product includes one or more programs. The computer program product may be applied to a terminal device or a network device according to the embodiments of the present disclosure, and the one or more programs cause a computer to perform the method performed by the terminal device or the network device according to the respective embodiments of the present disclosure.

In the above embodiments, the technical solutions may be totally or partially practiced by software, hardware, firmware or any combination thereof. During practice by software, the technical solutions may be totally or partially implemented in the form of a computer program product. The computer program product includes one or a plurality of computer-executable instructions. The computer program instructions, when loaded and executed on a computer, may cause the computer to totally or partially perform the procedures or functions in the embodiments of the present disclosure. The computer may be a general computer, a dedicated computer, a computer network, or another programming device. The computer-executable instructions may be stored in a computer-readable storage medium, or transferred from one computer-readable storage medium to another. For example, the computer-executable instructions may be transmitted from one website, computer, server or data center to another in a wired fashion, for example, a coaxial cable, an optical fiber, a digital subscriber line (DSL) or a wireless fashion, for example, an infrared ray, a radio, a microwave or the like.

Some embodiments of the present disclosure further provide a computer program. The computer program may be applied to a terminal device or a network device according to the embodiments of the present disclosure, and the program causes a computer to perform the method performed by the terminal device or the network device according to the respective embodiments of the present disclosure.

It should be understood that in the present disclosure, the terms “system” and “network” in the specification are generally exchanged. Further, the terms used herein are for the purpose of describing particular embodiments only and are not intended to limit the present disclosure. The terms such as “first,” “second,” “third,” “fourth,” and the like in the specifications, claims and the accompanying drawings of the present disclosure are intended to distinguishing different objects but are not intended to define a specific sequence. In addition, terms “comprise,” “include,” and variations thereof are intended to define a non-exclusive meaning.

In the embodiments of the present disclosure, the term “indication” mentioned in the specification may indicate a direct indication, an indirect indication, or an association. By way of example, the expression “A indicates B” may mean that A directly indicates B, e.g., B may be obtained by A; or mean that A indicates B indirectly, for example A indicates C, and B may be obtained by C; or mean that an association is present between A and B.

In the embodiments of the present disclosure, the term “correspond” or derivatives thereof may mean that there is a direct correspondence or an indirect correspondence between the two, that there is a correlation between the two, and that there is a relationship between indicating and being indicated, configuring and being configured, or the like.

In embodiments of the present disclosure, the term “pre-defined” or “pre-configured” may be implemented by pre-storing a corresponding code, table, or other means that may be used to indicate relevant information in a device (e.g., including a terminal device and a network device), and the present disclosure does not limit the specific implementation thereof. For example, the term “predefined” may refer to “defined in the protocol.”

In embodiments of the present disclosure, the term “protocol” may refer to a standard protocol in the field of communications, and may include, for example, the LTE protocol, the NR protocol, and related protocols used in future communication systems, without limitation.

However, it should also be understood that determining B from A does not mean determining B from A alone, and B may also be determined from A and/or other information.

In the description of the embodiments of the present disclosure, the term “and/or” is merely an association relationship for describing associated objects, which represents that there may exist three types of relationships. For example, the phrase “A and/or B” may indicate (A), (B), or (A and B). In addition, the forward-slash symbol “/” generally represents an “or” relationship between associated objects before and after the symbol.

It should be understood that in various embodiments of the present disclosure, the sequence numbers of the above various processes or steps do not denote a preferred sequence of performing the processes or steps; and the sequence of performing the processes and steps should be determined according to the functions and internal logics thereof, which shall not cause any limitation to the implementation process of the embodiments of the present disclosure.

In the several embodiments provided in the present disclosure, it should be understood that the disclosed system, apparatus and method may be practiced in other manners. The above-described device embodiments are merely illustrative. For example, the unit division is merely logical function division and may be other divisions in actual practice. For example, a plurality of units or components may be combined or integrated into another device, or some features may be ignored or not performed. Additionally, the displayed or discussed mutual couplings or direct couplings or communication connections may be implemented through some interfaces. The indirect couplings or communication connections between the devices or units may be implemented in electronic, mechanical or other forms.

The units which are described as separate components may be physically separated or may be not physically separated, and the components which are illustrated as units may be or may not be physical units, that is, the components may be located in the same position or may be distributed into a plurality of network units. Some of or all of the units may be selected according to actual needs to achieve the objectives of the solutions of the embodiments.

In addition, functional units in the embodiments of the present disclosure may be integrated into one processing unit, or each of the units may exist along physically, or two or more units may be integrated into one unit.

The above embodiments are used only for illustrating the present disclosure, but are not intended to limit the protection scope of the present disclosure. Various modifications and replacements readily derived by those skilled in the art within technical disclosure of the present disclosure shall fall within the protection scope of the present disclosure. Therefore, the protection scope of the present disclosure is subject to the appended claims.

What is claimed is:

1. A method for wireless communication, comprising:
determining, by a first terminal device, a first orthogonal cover code (OCC) sequence;
determining, by the first terminal device based on first information, a start time-domain position for an uplink transmission based on the first OCC sequence; and
performing, by the first terminal device, an uplink transmission by using the first OCC sequence, wherein the first OCC sequence is an OCC sequence in an OCC sequence set that is received from a network device, and the first information is associated with timing of at least one of the OCC sequence set or the uplink transmission.

2. The method according to claim 1, wherein the OCC sequence set is determined based on a plurality of subsets, and each OCC sequence in the OCC sequence set is determined based on a product of at least two subsets in the plurality of subsets.

3. The method according to claim 2, wherein the plurality of subsets comprise a first subset and a second subset, wherein a plurality of OCC sequences in the first subset correspond to a plurality of frequency-domain units within a same time-domain unit, and a plurality of OCC sequences in the second subset correspond to a plurality of time-domain units within a same frequency-domain unit.

4. The method according to claim 1, wherein the uplink transmission performed by the first terminal device using the first OCC sequence is a first uplink transmission, wherein the first uplink transmission comprises transmission of a first transport block, a size of the first transport block being determined based on a spreading factor corresponding to the first uplink transmission.

5. The method according to claim 4, wherein the first transport block is transmitted over a first resource, and the spreading factor is determined based on at least one of a length of the OCC sequence set or a quantity of terminal devices reusing the first resource.

6. The method according to claim 1, further comprising:
transmitting, by the first terminal device, second information to the network device;
wherein the second information indicate whether the first terminal device supports an uplink transmission based on an OCC sequence.

7. The method according to claim 1, further comprising:
receiving, by the first terminal device, third information from the network device;
wherein the third information is carried in downlink control information (DCI), and the third information indicates the first OCC sequence, or is used to determine the first OCC sequence in the OCC sequence set.

8. The method according to claim 1, wherein the uplink transmission comprises physical uplink shared channel (PUSCH) repetition transmissions corresponding to a same number of repetition transmissions.

9. The method according to claim 1, wherein the first information comprises at least one of:
a number of repetitions for a physical uplink shared channel (PUSCH);
a first timing related to an OCC sequence in a serving cell where the first terminal device is located;
a second timing corresponding to the OCC sequence set; or
a start time of the uplink transmission.

10. The method according to claim 9, wherein the OCC sequence set comprises N OCC sequences, N is a positive integer, and the number of repetition transmissions is M, M is a positive integer, wherein in a case where M is greater than N, the first OCC sequence is used for any N consecutive repetition transmissions in the M repetition transmissions, and the start time-domain position is determined based on a time-domain position of a first repetition transmission of the any N consecutive repetition transmissions.

11. The method according to claim 9, wherein a start time of the OCC sequence set is determined based on the first timing or the second timing, and the start time-domain position is determined based on the first timing and a first offset value, or the start time-domain position is determined based on the second timing and a second offset value.

12. The method according to claim 9, wherein the first timing is determined based on at least one of a number of repetitions of uplink transmissions within a serving cell or ephemeris parameters of a satellite corresponding to the serving cell.

13. The method according to claim 9, wherein the first OCC sequence is used for physical uplink shared channel (PUSCH) transmission, wherein a start time-domain position of the PUSCH transmission is determined based on an offset index corresponding to the PUSCH transmission, the offset index being determined based on the first information.

14. The method according to claim 13, wherein the start time-domain position Kₛ_{_{occ}} is:
$${K}_{{s}_{occ}} = ⌊ n \cdot \frac{{2}^{{μ}_{PUSCH}}}{{2}^{{μ}_{PDCCH}}} ⌋ + {K}_{2} + {K}_{offset} \cdot \frac{{2}^{{μ}_{PUSCH}}}{{2}^{{μ}_{{K}_{offset}}}} + {index}_{offset} ;$$
wherein index_{offset} represents the offset index, n represents a slot scheduled by downlink control information (DCI), μ_{PUSCH} and μ_{PDCCH} respectively represent a subcarrier spacing configuration for the PUSCH and a subcarrier spacing configuration for a physical downlink control channel (PDCCH), K₂ represents a dataset parameter of the PUSCH, K_{offset} represents an offset parameter, and μ_{K}_{_{offset}} represents a subcarrier spacing configuration related to a frequency range.

15. A method for wireless communication, comprising:
determining, by a network device based on first information, a start time-domain position for an uplink transmission performed by a first terminal device based on a first orthogonal cover code (OCC) sequence; and
receiving a first uplink transmission from the first terminal device based on the first OCC sequence;
wherein the first OCC sequence is an OCC sequence in an OCC sequence set sent to the first terminal device, wherein the OCC sequence set is configured for at least one terminal device including the first terminal device to respectively perform a corresponding uplink transmission, and the first information is associated with timing of at least one of the OCC sequence set or the uplink transmission of the at least one terminal device.

16. An apparatus, comprising:
at least one processor; and
one or more non-transitory computer-readable storage media coupled to the at least one processor and storing programming instructions for execution by the at least one processor, wherein the programming instructions, when executed, cause the apparatus to perform operations comprising:
determining a first orthogonal cover code (OCC) sequence;
determining, based on first information, a start time-domain position for an uplink transmission based on the first OCC sequence; and
performing, an uplink transmission by using the first OCC sequence, wherein the first OCC sequence is an OCC sequence in an OCC sequence set that is received from a network device, and the first information is associated with timing of at least one of the OCC sequence set or the uplink transmission.

17. The apparatus according to claim 16, wherein the OCC sequence set is determined based on a plurality of subsets, and each OCC sequence in the OCC sequence set is determined based on a product of at least two subsets in the plurality of subsets.

18. The apparatus according to claim 17, wherein the plurality of subsets comprise a first subset and a second subset, wherein a plurality of OCC sequences in the first subset correspond to a plurality of frequency-domain units within a same time-domain unit, and a plurality of OCC sequences in the second subset correspond to a plurality of time-domain units within a same frequency-domain unit.

19. The apparatus according to claim 16, wherein the uplink transmission is performed by using the first OCC sequence is a first uplink transmission, wherein the first uplink transmission comprises transmission of a first transport block, a size of the first transport block being determined based on a spreading factor corresponding to the first uplink transmission.

20. The apparatus according to claim 19, wherein the first transport block is transmitted over a first resource, and the spreading factor is determined based on at least one of a length of the OCC sequence set or a quantity of terminal devices reusing the first resource.
